(19) United States
(12) Patent Application Publication
(10) Pub. No.: US 2025/0153173 A1
(43) Pub. Date: May 15, 2025

(54) MICROFLUIDIC DEVICE COMPRISING MEMBERS FOR RETAINING OBJECTS WITHIN CAPILLARY TRAPS

(71) Applicant: SYNCHROTRON SOLEIL, Saint-Aubin (FR)

(72) Inventors: Ramakrishna VASIREDDI, Pinapenki (IN); Léonard CHAVAS, Nagoya (JP)

(21) Appl. No.: 18/833,812

(22) PCT Filed: Jan. 13, 2023
(86) PCT No.: PCT/EP2023/050684

§ 371 Date: Jul. 26, 2024

(30) Foreign Application Priority Data
Feb. 7, 2022 (FR) 2201027

(51) Int. Cl. B01L 3/00

(52) U.S. Cl. CPC B01L 3/502761; B01L 3/502715; B01L 2300/0883; B01L 2400/086

(57) ABSTRACT

A microfluidic device including capillary traps each provided with a microcavity formed on a wall of a microchannel for circulating a fluid and with a retaining member extending in the microchannel opposite the microcavity of the capillary trap so as to retain objects previously trapped in the microcavity when the objects move from the microcavity toward the retaining member, for example due to a change in the flow direction of the fluid in the microchannel.

### TECHNICAL FIELD

The invention relates to the field of microfluidics and lab-on-a-chip systems.

The invention is of particular, non-limiting, interest for the crystallographic study of biological macromolecules.

### PRIOR ART

Microfluidics can be defined as the study of flows and their implementation in microchannel networks with dimensions in the micrometer range. At this scale, capillary forces predominate over the forces of gravity.

Conventionally, a microfluidic device comprises capillary traps designed to trap objects such as crystals or biological cells for analysis. These traps typically consist of cavities formed along microchannels in which a liquid is moved, the objects being suspended in this liquid.

An example of a microfluidic device and crystal analysis method is described in the paper by Lyubimov et al, entitled “Capture and X-ray diffraction studies of protein microcrystals in a microfluidic trap array” and published in Acta Crystallographica D71, pages 928-940, in 2015.

Liquid is typically introduced into the microchannels via an injection tube which is disconnected once the device has been filled, causing a liquid suction phenomenon which tends to force the objects to leave the capillary traps.

There is therefore a need to improve object capture for analysis.

### DISCLOSURE OF THE INVENTION

To this end, the object of the invention is a microfluidic device comprising:
a support comprising a microchannel configured to allow a flow of fluid from a microchannel inlet to a microchannel outlet,
successive capillary traps between the inlet and outlet of the microchannel, each of the capillary traps comprising a microcavity formed on a wall of the microchannel so as to open into the microchannel in order to trap one or more objects suspended in the fluid as said fluid flows through the microchannel.

According to the invention, each of the capillary traps comprises a retaining member extending in the microchannel opposite the microcavity of said capillary trap.

Such a retaining member is thus configured to allow retention of at least one of the object(s) previously trapped in this microcavity when said object moves from said microcavity toward said retaining member.

The invention thus makes it possible to reduce the escape of objects trapped in the microcavities, particularly when the fluid changes direction of flow, for example when an injection tube is removed.

In particular, the invention improves the reproducibility of analysis results.

In the present description, a microchannel is a channel whose diameter or largest transverse dimension is in the micrometer range, that is, a dimension less than 1 mm and greater than or equal to 1000 nm. Similarly, a microcavity is considered to be a cavity whose diameter or largest dimension is in the micrometer range, that is, a dimension less than 1 mm and greater than or equal to 1000 nm.

Without limitation, the objects may be crystals, cells or else particles also in the micrometer range, that is, less than 1 mm and greater than or equal to 1000 nm

The fluid may be liquid or gaseous.

In one embodiment, for each of the capillary traps, the retaining member comprises a retaining surface.

The retaining surface is a surface of the retaining member that extends opposite the microcavity of the corresponding capillary trap.

The retaining surface is preferably concave or recessed.

The retaining surface and/or more generally the retaining member may have an asymmetrical profile.

In one embodiment, for each of the capillary traps, the retaining member comprises a first edge delimiting an upstream end of the retaining surface and a second edge delimiting a downstream end of the retaining surface, the first edge being located at a first distance from the microcavity of said capillary trap, the second edge being located at a second distance from the microcavity of said capillary trap, the first distance being greater than the second distance.

The terms “upstream” and “downstream” are herein defined with reference to a flow direction of the fluid in the microchannel, for example when the fluid is introduced therein.

A different distance from the microcavity between the first edge and the second edge favors the capture of objects when the fluid flows in a direction from the inlet to the outlet of the microchannel and/or favors their retention when the fluid changes direction.

Without limitation, the second distance may be greater than 1.2 times the first distance, for example equal to or close to 1.5 times the first distance.

By way of example, the first distance may be 10 μm and the second distance may be 15 μm.

In one embodiment, for each of the capillary traps, the retaining member extends along a flow direction of the microchannel, having a width less than or equal to a width of the microcavity of said capillary trap.

Without limitation, the length of the retaining member may be less than 0.8 times the width of the microcavity, for example equal or close to 0.7 times the width of the microcavity.

As a non-limiting example, the width of the microcavity may be 40 μm and the length of the retaining member may be 28 μm.

In one embodiment, said microchannel is a primary microchannel, each of the capillary traps comprising a secondary microchannel opening into the microcavity of said capillary trap.

A secondary microchannel improves object capture within the corresponding capillary trap.

In one alternative embodiment, for each of the capillary traps, the secondary microchannel comprises:
a first end through which it opens into the microcavity of said capillary trap which opens into a section of the primary microchannel and
a second end through which it opens into another section of the primary microchannel.

Such an arrangement improves the efficiency of the capillary traps while reducing the compactness of the device.

In one embodiment, the device comprises an injection member such as a tube configured to introduce said fluid into the microchannel and means for connecting/disconnecting said injection member.

In other words, the device of the invention may comprise conventional fluid injection means.

The support may be a chip of a lab-on-a-chip type system.

Another object of the invention is a method for analyzing objects comprising a step of injecting a fluid into the microchannel of a microfluidic device as defined above, said objects being suspended in the fluid thus injected.

This method may comprise a step of optically detecting objects retained by the capillary traps of the microfluidic device, for example by irradiating the objects with X-rays.

Further advantages and features of the invention will become apparent from the following detailed, non-limiting description.

### BRIEF DESCRIPTION OF THE DRAWINGS

The following detailed description makes reference to the accompanying drawings in which:

FIG. 1 is a schematic view of a microfluidic device according to the invention, this device comprising a chip supporting a microfluidic network;

FIG. 2 shows a magnified view of part of the microfluidic network of the device shown in FIG. 1, more specifically revealing secondary microchannels belonging to capillary traps fluidically connected to a primary microchannel;

FIG. 3 is a further magnification of part of the microfluidic network shown in FIG. 2, revealing more precisely two adjacent capillary traps, each of said capillary traps comprising a microcavity, a secondary microchannel and a retaining member.

### DETAILED DESCRIPTION OF EMBODIMENTS

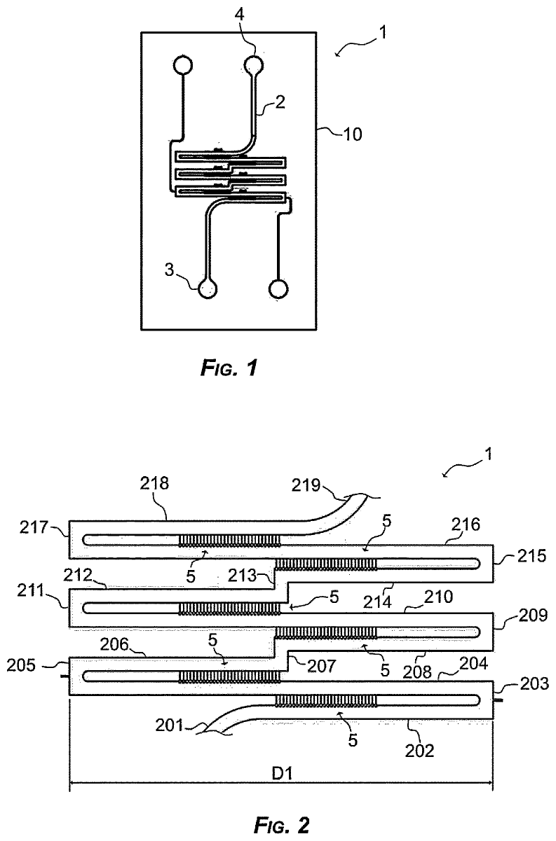

FIG. 1 shows a non-limiting example of a microfluidic device 1 in accordance with the invention.

The device 1 comprises a support 10 forming a chip of a lab-on-chip system.

The support 10 comprises a microfluidic network forming a so-called primary microchannel 2, having an inlet 3 and an outlet 4.

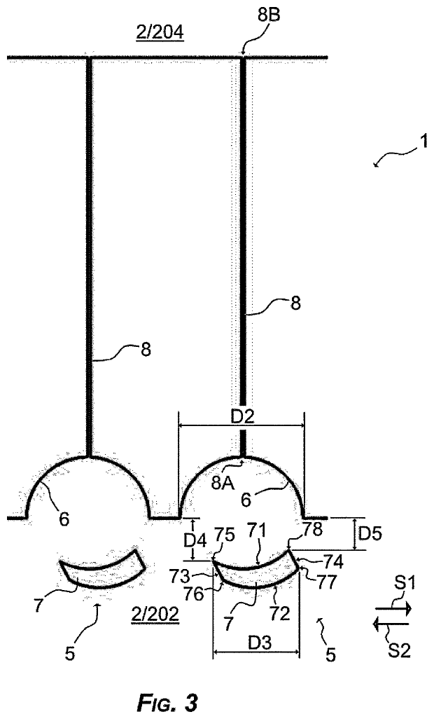

With reference to FIG. 2, the microchannel 2 comprises sections 201-219 defining a serpentine flow path or direction, notably allowing the compactness of the device 1 to be increased.

Section 201, partially shown in FIG. 2, comprises one end forming the inlet 3 of the microchannel 2 and another end connected to section 202. Similarly, section 219, partially shown in FIG. 2, comprises one end forming the outlet 4 of the microchannel 2 and another end connected to section 218.

In this example, sections 202, 204, 206, 208, 210, 212, 214, 216 and 218 extend parallel to one another and sections 203, 205, 207, 209, 211, 213, 215 and 217 connect sections 202 and 204, 204 and 206, 206 and 208, 208 and 210, 210 and 212, 212 and 214, 214 and 216, 216 and 218 respectively to one another.

Sections 203, 209 and 215 on the one hand and 205, 211 and 217 on the other define a width DI of the microfluidic network.

In this example, sections 204, 210 and 216 extend over the entire width DI of the microfluidic network, while sections 202, 206, 208, 212, 214 and 218 extend over a distance corresponding to approximately half the width DI of the microfluidic network.

Considering a median axis passing between sections 203, 209 and 215 on the one hand and sections 205, 211 and 217 on the other, sections 206, 212 and 218 extend mainly on a first side of this median axis (on the left in FIG. 2) and sections 202, 208 and 214 extend mainly on a second side of this median axis (on the right in FIG. 2).

Such a geometry notably offers advantages in terms of the arrangement of the capillary traps 5 of the device 1, described below, and the operation of the device 1.

In this example, the microchannel 2 has a diameter of 200 μm and defines an overall volume of approximately 3.2 nL.

In a manner known per se, the microchannel 2 is used to convey a fluid from the inlet 3 to the outlet 4, introduced into the microchannel 2 by an injection member (not shown) such as a tube releasably connected to the inlet 3 of the microchannel 2.

In this example, the fluid is a liquid wherein objects are suspended.

Without limitation, the liquid can typically form a saline medium with a pH of between five and nine.

In this example, the objects suspended in the liquid are crystals in the micrometer range, that is, less than 1 mm and greater than or equal to 1000 nm, typically with an average size of between 10 μm and 15 μm.

The present description applies by analogy to an implementation of the device 1 with another fluid, for example a gaseous fluid, and/or objects other than crystals.

FIG. 3 shows two capillary traps 5 of the device 1.

Each of said capillary traps 5 comprises a microcavity 6, a retaining member 7 and a microchannel 8, known as the secondary microchannel.

In this example, the secondary microchannel 8 has a diameter of 10 μm.

The capillary trap 5 located on the right of FIG. 3 will now be described.

The microcavity 6 is formed on a wall of the primary microchannel 2 so as to open out into the primary microchannel 2 via an opening of width D2, the width D2 being considered in the direction of flow.

In this example, the microcavity 6 has a hemispherical shape so that the aforementioned opening is circular. The width D2 thus corresponds to an opening diameter of the microcavity 6.

The secondary microchannel 8 comprises a first end 8A, through which it opens into the microcavity 6, and a second end 8B, through which it opens into the primary microchannel 2.

In this particular example, this secondary microchannel 8 opens via its second end 8B into the section 204 of the primary microchannel 2 and via its first end 8A into the microcavity 6, which opens into the section 202 of the primary microchannel 2 (see FIGS. 2 and 3).

Still referring to the capillary trap 5 on the right of FIG. 3, the retaining member 7 extends into the primary microchannel 2, in this case in section 202, opposite the microcavity 6 of this capillary trap 5.

The retaining member 7 comprises a surface 71, a so-called retaining surface, which extends opposite the microcavity 6, an opposite surface 72, an upstream surface 73 and a downstream surface 74.

The terms “upstream” and “downstream” refer to a direction of flow SI of the liquid in the primary microchannel 2 as it moves from the inlet 3 toward the outlet 4.

The surfaces 71-74 of the retaining member 7 are separated from each other by edges 75-78 forming in this example ridges. Edge 75 delimits surfaces 71 and 73, edge 76 delimits surfaces 72 and 73, edge 77 delimits surfaces 72 and 74 and edge 78 delimits surfaces 71 and 74.

Surfaces 71 and 72 define a thickness of the retaining member 7.

In the direction of flow, the retaining member 7 has a width D3 which in this example corresponds to a distance between edges 75 and 77, edge 75 delimiting an upstream end of both the retaining surface 71 and of the retaining member 7, edge 77 delimiting a downstream end of both the opposite surface 72 and of the retaining member 7.

The width D3 of the retaining member 7 is less than the width D2 of the microcavity 6. In this particular example, D2 is equal to 40 μm and D3 is equal to 28 μm.

The retaining member 7 is located at a distance from the microcavity 6.

More precisely, edge 75 is located at a distance D4 from the microcavity 6, that is, from said opening of the microcavity 6, while edge 78, which delimits a downstream end of the retaining surface 71, is located at a distance D5 from microcavity 6, that is, from said opening of the microcavity 6.

Distance D4 is herein greater than distance D5. In this example, D4 is equal to 15 μm and D5 is equal to 10 μm.

The retaining member 7 has an asymmetrical geometry. In particular, the thickness of the retaining member 7 is smaller at its upstream end than at its downstream end.

In this example, the retaining surface 71 is concave and the opposite surface 72 is convex.

Such geometry and dimensions of the retaining member 7 both reduce disturbances to the liquid flow in the microchannel 2 and contribute to the capture and retention of objects within said capillary trap 5.

The above description applies by analogy to the capillary trap 5 on the left of FIG. 3 and to each of the other capillary traps 5 shown in FIG. 2.

With reference to FIG. 2, the various capillary traps 5 of device 1 follow one another in a series of 30 adjacent capillary traps 5 between the inlet 3 and the outlet 4 of the primary microchannel 2.

A first series of capillary traps 5 follow one another along section 202 in the sense that the microcavity 6 of each of these capillary traps 5 opens into section 202 and the retaining member 7 of each of these capillary traps 5 extends into section 202, the secondary microchannel 8 of each of these capillary traps 5 opening out at their second end 8B into section 204.

Similarly, a second series of capillary traps 5 follow one another along section 204, their microcavity 6 opening into section 204, their retaining member 7 extending into section 202, their secondary microchannel 8 opening out at their second end 8B into section 206. A third series of capillary traps 5 follow one another along section 208, their microcavity 6 opening into section 208, their retaining member 7 extending into section 208, their secondary microchannel 8 opening out at their second end 8B into section 210. A fourth series of capillary traps 5 follow one another along section 210, their microcavity 6 opening into section 210, their retaining member 7 extending into section 210, their secondary microchannel 8 opening out at their second end 8B into section 212.

A fifth series of capillary traps 5 follow one another along section 214, their microcavity 6 opening into section 214, their retaining member 7 extending into section 214, their secondary microchannel 8 opening out at their second end 8B into section 216. A sixth series of capillary traps 5 follow one another along section 216, their microcavity 6 opening into section 216, their retaining member 7 extending into section 216, their secondary microchannel 8 opening out at their second end 8B into section 218.

The microfluidic network of device 1 is thus formed by the primary microchannel 2 and all the secondary microchannels 8 of the capillary traps 5.

When liquid is injected into the microchannel 2 via its inlet 3, the various capillary traps 5 each allow one or more objects suspended in the liquid to be retained within the microcavity 6. Typically, objects enter a trap 5 through the space extending between the microcavity 6 and the upstream end of the corresponding retaining member 7.

Object capture is notably facilitated by the resistance of the various parts of the microfluidic network to liquid flow, which changes as capture progresses. More specifically, as the secondary microchannels 8 have a lower hydraulic resistance than the primary microchannel 2, objects located at a certain position along the flow direction will tend to move toward a secondary microchannel 8 near which they are located so as to lodge in the microcavity 6 of the corresponding capillary trap 5. Objects captured in this way tend to block said secondary microchannel 8, locally increasing hydraulic resistance, so that uncaptured objects tend to move towards the capillary traps 5 further downstream.

When the injection tube is removed from the device 1, a suction phenomenon occurs typically causing a change in the direction of flow of the liquid moving it in a direction S2 from the outlet 4 toward the inlet 3 of the primary microchannel 2, or causing the liquid to move back and forth within said microchannel 2. Typically, the removal of the injection tube produces a vacuum, corresponding to a volume of around 5 μL in this example, which draws the liquid located in the microfluidic network out of said network, said suction vacuum volume being in this case much greater than the overall volume of the liquid filling the microchannel 2, that is, around 3.2 nL in this example. This typically tends to cause the objects to leave the microcavities 6 wherein they were trapped, and to move at least some of them toward the retaining members 7 given the arrangement of said retaining members opposite the microcavities 6. The geometry of the retaining members 7, in particular in this example the concavity of the retaining surface 71 and the arrangement of the upstream edge 75, contribute to retaining these objects in the traps 5.

An analysis can then be carried out, for example by optical detection of the objects thus retained in the capillary traps 5.

The microfluidic device 1 described above can be adapted in many ways, particularly in terms of the geometry and/or size of the microchannel 2, the capillary traps 5 and/or, in particular, the retaining members 7, depending, for example, on the type of objects to be analyzed and/or the nature of the transport fluid used. Thus, in a variant not shown, said retaining surface may have a hollow non-curved shape. For another example, the position and/or orientation of the retaining members may be different from those shown in FIG. 3.

1. A microfluidic device comprising:
a support comprising a microchannel configured to allow a flow of fluid from an inlet of the microchannel to an outlet of the microchannel;
capillary traps follow one another between the inlet and outlet of the microchannel, each of the capillary traps comprising a microcavity formed on a wall of the microchannel so as to open into the microchannel in order to trap one or more objects suspended in the fluid as the latter flows through the microchannel; and
each of the capillary traps comprises a retaining member extending in the microchannel opposite the microcavity of said capillary trap.

2. The device according to claim 1, wherein, for each of the capillary traps, the retaining member comprises a concave retaining surface.

3. The device according to claim 2, wherein, for each of the capillary traps, the retaining member comprises a first edge delimiting an upstream end of the retaining surface and a second edge delimiting a downstream end of the retaining surface, the first edge being located at a first distance from the microcavity of said capillary trap, the second edge being located at a second distance from the microcavity of said capillary trap, the first distance being greater than the second distance.

4. The device according to claim 1, wherein, for each of the capillary traps, the retaining member extends along a flow direction of the microchannel, having a width less than or equal to a width of the microcavity of said capillary trap.

5. The device according to claim 1, wherein said microchannel is a primary microchannel, each of the capillary traps comprising a secondary microchannel opening into the microcavity of said capillary trap.

6. The device according to claim 5, wherein, for each of the capillary traps, the secondary microchannel comprises:
a first end through which it opens into the microcavity of said capillary trap, which opens into a section of the primary microchannel, and
a second end through which it opens into another section of the primary microchannel.

7. The device according to claim 1, comprising an injection member such as a tube configured to introduce said fluid into the microchannel and means for connecting/disconnecting said injection member.

8. The device according to claim 1, wherein the support is a chip of a lab-on-a-chip type system.

9. A method for analyzing objects comprising a step of injecting a fluid into the microchannel of a microfluidic device according to claim 1, said objects being suspended in the fluid thus injected.

10. The method according to claim 9, comprising a step of optically detecting objects retained by the capillary traps of the microfluidic device.
